(19) United States
(12) Patent Application Publication
(10) Pub. No.: US 2020/0000065 A1
(43) Pub. Date: Jan. 2, 2020

(54) RETRACTABLE LEASH WITH PIVOTABLE OUTLET

(71) Applicant: flexi-Bogdahn Technik GmbH & Co. KG, Bargteheide (DE)

(72) Inventors: Manfred BOGDAHN, Hamburg (DE); Thomas LAU, Neustadt in Holstein (DE)

(21) Appl. No.: 16/454,412

(22) Filed: Jun. 27, 2019

(30) Foreign Application Priority Data
Jun. 27, 2018 (DE) 10 2018 115 523.9

(51) Int. Cl. A01K 27/00

(52) U.S. Cl. CPC A01K 27/004

(57) ABSTRACT

Described is a retractable leash device (1) as well as a process for rolling up and unrolling a leash (4) for leading an animal. The retractable leash device (1) has a handle (2) and a housing (3) for the accommodation of the leash (4) which can be rolled up and unrolled, and a mechanism which exerts a restoring force at least at times on the at least partly unrolled leash (4) is provided in the housing (3). An outlet opening (6), at which the leash (4) comes out of the housing (3), can be moved into at least two positions in relation to the handle (2).

### CROSS REFERENCE TO RELATED APPLICATIONS

This application claims the benefit of priority under 35 U.S.C. § 119 of German Application 10 2018 115 523.9, filed Jun. 27, 2018, the entire contents of which are incorporated herein by reference.

### TECHNICAL FIELD

The present invention pertains to a retractable leash device for leading animals that has a handle and a housing for the accommodation of a leash that can be rolled up and unrolled. A mechanism which exerts a restoring force on the leash is provided in the housing, so that, as soon as it is at least partly unrolled and no pull is acting on the leash, this leash is automatically pulled into the housing and is rolled up here.

### TECHNICAL BACKGROUND

So-called retractable leashes are generally specially configured leashes which are, as a rule, used for leading dogs. In this connection, belts or ropes are defined as a leash as well. In comparison to the conventional dog leashes, retractable leashes are characterized in that they have a spring-loaded coil in a handle housing, about which coil the leash or the rope is automatically wound up. As a result, the leash is always under a slight tension and it is ensured that this leash does not drag on the ground, namely as a function of the distance between the animal being led and the owner. It is particularly advantageous here that the animal being led with the leash can move relatively freely. Furthermore, many of the prior-art retractable leashes have a lock or a brake, with which the owner can limit the run of the animal at any time, can especially set the run at a desired length and, if necessary, can reduce the distance between him and the animal being led.

A retractable leash for leading animals of the type of this class is known from DE 20 2006 002147 U1. The retractable leash described has a housing with a handle and a spring-loaded coil within the housing, which coil is mounted rotatably about an axis of rotation and about which coil the leash is automatically rolled up when pulling decreases. Furthermore, a locking device is provided, with which the leash can be locked in an at least partially unrolled position as needed. The technical solution described is characterized in that an outlet opening, through which the leash comes out of the housing, is arranged movably in relation to the housing at least partly in the pulling direction or in the extension direction of the leash. Based on this configuration, the outlet opening moves, e.g., in the form of a bushing, in the pulling direction of the leash, as soon as the unrolled leash reaches an end stop and the animal being led continues to pull. The friction and thus the wear of the leash shall be reduced in this manner.

The problem with the use of retractable leashes is often that the force is introduced into the housing and into the handle connected thereto from different directions because of the varying distances between the animal owner and the animal being led and varying pulling force, which leads at least at times to a non-ergonomic hand position of the animal owner and to increased friction in the area of the outlet opening. Especially when leading animals, for example, dogs, which tend to pull on the leash, the pulling direction varies considerably in some cases between a situation, in which the animal “heels” and a situation, in which the dog is pulling. This may lead to the hand of the animal owner being pinched at the end of the handle or the differences in the pulling direction of the leash having to be compensated for by the owner by a change in the holding of the hand and arm. This varying tension in the area of the handle is usually perceived as uncomfortable, uncomfortable or even as strenuous by animal owners when leading their animals, especially in case of dogs which are large and/or pull strongly, and in the case of longer distances. In some cases, this problems represents a considerable impairment especially for older animal owners or animal owners with problems in the hands, arms or in the shoulder-neck area. Moreover, the increased friction in the area of the outlet opening leads to increased wear.

### SUMMARY

The problem with the use of retractable leashes is often that the force is introduced into the housing and into the handle connected thereto from different directions because of the varying distances between the animal owner and the animal being led and varying pulling force, which leads at least at times to a non-ergonomic hand position of the animal owner and to increased friction in the area of the outlet opening. Especially when leading animals, for example, dogs, which tend to pull on the leash, the pulling direction varies considerably in some cases between a situation, in which the animal “heels” and a situation, in which the dog is pulling. This may lead to the hand of the animal owner being pinched at the end of the handle or the differences in the pulling direction of the leash having to be compensated for by the owner by a change in the holding of the hand and arm. This varying tension in the area of the handle is usually perceived as uncomfortable, uncomfortable or even as strenuous by animal owners when leading their animals, especially in case of dogs which are large and/or pull strongly, and in the case of longer distances. In some cases, this problems represents a considerable impairment especially for older animal owners or animal owners with problems in the hands, arms or in the shoulder-neck area. Moreover, the increased friction in the area of the outlet opening leads to increased wear.

Based on the retractable leash devices known from the state of the art as well as on the problems as explained above, the object of the present invention is to perfect a retractable leash device such that a comfortable holding of the retractable leash device and thus a leading of the animal are possible for the owner even under different conditions, especially in the case of varying pulling directions of the leash. The technical solution being indicated here shall always guarantee a good, secure grip for the person leading an animal Δt the same time, the fundamental configuration and the functionality of the novel retractable leash device shall essentially correspond to those of the prior-art retractable leash device. Further, the corresponding technical solution shall be able to be implemented without considerable design effort and the costs connected thereto.

The present invention pertains to a retractable leash device with a handle and with a housing, in which a leash for leading animals is accommodated, preferably by means of a rotatable coil, such that the leash can be rolled up and unrolled, and a mechanism which exerts a restoring force at least at times on the at least partly unrolled leash is provided in the housing. The retractable leash device is configured according to the present invention such that an outlet opening, through which the leash comes out of the housing, can be moved into at least two positions in relation to the handle. Thus, a retractable leash device configured according to the present invention has at least one element that initiates or makes possible a movement of the outlet opening in relation to the handle. The essential idea of the present invention is thus that the outlet opening, through which the leash, which can be rolled up and unrolled, is led out of the housing, does not have a fixed position in relation to the handle and/or in relation to the housing which has a handle, but rather is movable in relation to the handle and/or in relation to the housing. Due to the provision of suitable elements, it is achieved that the outlet opening can be moved into at least two different positions in relation to the handle and/or in relation to the housing.

In this manner, the angle between the leash and the handle is adapted to the corresponding state of operation.

The position of the outlet opening is advantageously changed as a function of the pulling direction of the leash, especially of the at least partly unrolled leash. The retractable leash device configured according to the present invention with variable outlet opening is adapted here to the corresponding situation during the leading of an animal and will always make possible a good, secure grip for the person leading an animal. The outlet opening is located in the vicinity of the handle or else at a greater distance from the handle as a function of the pulling direction of the leash, which especially depends on the distance of the animal being led from the retractable leash device and thus on the length of the unrolled part of the available leash. It is advantageous here if the outlet opening is located in the corresponding state of operation in a tangential position, in which the leash extends tangentially through the outlet opening up to the coil. Regardless of the length of the unrolled part of the leash and the pulling force, the handle thus always occupies the optimal alignment in relation to the pulling direction. The retractable leash device according to the present invention preferably has at least one means to hold the outlet opening in the nontensioned state of the leash, e.g., when the animal “heels” in a position, in which the distance between the outlet opening and the handle is minimal. The means preferably have at least one spring, especially a coil spring or helical spring, with which a suitable pretension is generated.

According to a special embodiment of the present invention, provisions are made for the housing to have an open outlet area, within which the position of the outlet opening is variable. In this case, the outlet opening is at different points of the outlet area depending on the situation when leading an animal. In order to be able to reliably prevent an animal owner from catching, for example, a finger in the open outlet area, a cover element is preferably provided, which cover element at least at times closes the areas of the outlet area, in which the outlet opening is not located. This cover element is preferably a displaceable cover, which is pushed automatically, preferably by means of a spring force, over the open part of the outlet area, in which the outlet opening is not located.

A special variant provides for the housing together with the leash which is at least partly rolled up therein to be arranged movably in relation to the handle. According to this special embodiment, the housing, in which the leash is preferably wound up and unwound about the axis of rotation of a coil, is thus movable in relation to the handle. In this case, the outlet opening is located in the movably arranged housing and is moved, as needed, together with the housing in relation to the handle. The housing with the outlet opening provided therein is also moved in this case as a function of a pulling direction of the leash. If the animal being led is located at a further distance from the retractable leash device and is pulling on the leash, then the housing with the outlet opening provided therein is moved such that the distance between the outlet opening and the handle is greater than when the animal is located in the vicinity of the retractable leash device, especially when it “heels.”

Provisions are made in an alternative embodiment of the present invention for a lever element, which contacts the leash in at least some areas and through the movement of which the outlet opening is displaced, especially pivoted in relation to the housing, to be fastened to the housing. The lever element preferably has a deflection area, over which the leash is guided and which is moved in case of a movement of the lever element such that the outlet opening is displaced, especially pivoted together with the leash either in the direction of the handle or in the reverse direction, as needed or on a situation-related basis.

The lever element is preferably pivotable about an axis, which coincides with the axis of rotation of the coil, about which the leash is wound up at least partly. The lever element is thus pivoted about the pivot axis for displacing the outlet opening in relation to the handle and/or in relation to the housing of the retractable leash device.

According to another embodiment of the present invention, provisions are made for the mechanism for applying a restoring force on the leash to have at least one spring element. The spring element is preferably arranged in the interior of the housing and acts on a coil, about which the leash is wound up. In this case, the coil is mounted rotatably about an axis of rotation and is acted on by a spring force such that a restoring force is exerted on the at least partly unrolled leash, so that the leash is wound up about the coil when the pulling force decreases. The spring force is selected such that the leash is reliably tensioned and is rolled up when the pulling force decreases, without the animal being led with the leash being impaired as a result. The spring element is preferably a coil spring or a helical spring.

Furthermore, provisions are advantageously made for a retractable leash device which is configured according to the present invention to have a lock, by means of which the leash can be fixed or braked or locked in an at least partly unrolled position. Such a locking mechanism ensures that the run of the animal being led can be limited as needed and possibly the distance between the owner and the animal being led can be reduced as needed. In addition to the device, the present invention also pertains to a process for rolling up and unrolling a leash for leading animals. In case of the process, the leash is at least at times wound up or unwound about a coil at least indirectly connected to a handle. The process is configured according to the present invention such that an angle between the pulling direction of the leash and a central axis of the handle, which central axis runs in the longitudinal direction of the handle, is changed at least at times. The angle described above is changed as a function of the distance of the animal from the animal owner and the pulling direction connected therewith.

If the animal is located in the direct vicinity of the owner, for example, it “heels,” the angle between the central line of the handle and the pulling direction of the leash will be relatively small or even minimal.

If now the animal is moving away from the animal owner, so that the leash unrolls due to pulling, the outlet opening pivots at the housing downwards together with the housing according to a special embodiment, such that the angle between the central axis of the handle and the pulling direction is increased.

Regardless of whether the device or the process according to the present invention is accomplished, the essential idea of the present invention is that the outlet opening is located in the upper position, provided the dog heels and is not pulling, the distance between the outlet opening and the handle is minimal and thus a low-friction inlet and outlet of the leash tangentially to the coil, about which it is wound up, is guaranteed. Provided the animal is pulling on the leash, the outlet opening pivots downwards and the distance between the outlet opening and the handle and the angle between the pulling direction of the leash and the central axis of the handle increase.

The present invention will be explained in more detail below with reference to the figures without limiting the general idea of the present invention on the basis of special exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view showing a retractable leash device with a housing part arranged pivotably to the handle while an animal “heels;”

FIG. 2 is a side view showing a retractable leash device with a housing part arranged pivotably to the handle while an animal is pulling on the leash;

FIG. 3 is a side view showing a retractable leash device with a lever element for moving the outlet opening while an animal “heels;” and

FIG. 4 is a side view showing a retractable leash device with a lever element for moving the outlet opening while an animal is pulling on the leash.

### DESCRIPTION OF PREFERRED EMBODIMENTS

Referring to the drawings, FIG. 1 shows a retractable leash device 1 configured according to the present invention with a handle 2 and with a housing 3, in which the leash 4 is rolled up and unrolled about a rotatably mounted coil as needed during the leading of an animal, especially of a dog. In this case, the coil is in active connection with a mechanism, which exerts a restoring force on the at least partly unrolled leash 4, so that this leash 4 is automatically pulled into the housing 3 and rolled up when the pulling on the leash 4 decreases. The mechanism has for this a spring, which is not shown in the figure, with a spring force, which brings about the respectively needed restoring force on the leash 4. The restoring force is selected such that the at least partly unrolled leash 4 is always tensioned and is rolled up in the housing 3 and about the coil when the pulling decreases, without the animal being led with the leash being impaired as a result.

Furthermore, the retractable leash device 1 shown in FIG. 1 has a locking mechanism, which is activated as needed by the owner via a pushbutton 9 and fixes the leash 4 in the position located at this time. The animal being led can thus be led at a constant distance to the animal owner or the distance between the animal and the animal owner can be reduced as needed.

According to the embodiment shown in FIG. 1, the housing 3, in which the leash is rolled up and unrolled about a rotatably mounted coil, is configured as pivotable in relation to the handle 2. This means that the handle 2 and the pivotable housing 3 perform a movement in relation to one another during the pivoting. In the exemplary embodiment being shown, the housing 3 pivots in relation to the handle 2 about a pivot axis 8, which coincides with the axis of rotation of the coil, about which the leash 4 is at least partly wound up. Since an outlet opening 6 is provided in the pivotable housing 3 for the leash 4, this outlet opening 6 is likewise moved in relation to the handle 2 during a pivoting movement. Based on this outlet opening means to move an outlet opening, the distance between the outlet opening 6 provided in the housing 3 and the handle 2 can be varied. In this case, the distance is adapted to the corresponding situation during the leading of the animal.

FIG. 1 shows the retractable leash device 1 in a situation in which the animal being led, especially a dog, is heeling and is not pulling. The outlet opening 6 is located in the upper position, so that the distance between the outlet opening 6 and the handle 2 is minimal and thus a low-friction inlet and outlet of the leash 4 tangentially to the coil, on which the leash is at least partly wound up in the interior of the housing 3, is achieved. In this situation, in addition to holding the animal, the leash 4 runs from the outlet opening 6 obliquely downwards to the animal being led, especially a dog being led. A low-friction leash outlet is achieved here when the outlet opening 6 is located at the housing 3 within easy reach at the top. If the outlet opening 6 were located further downwards, i.e., located at a greater distance from the handle 2, in this situation, a free outlet of the leash 4 would be strongly hindered due to a kinking of the leash 4 in the area of the outlet opening 6 and the handling would not be so comfortable for the animal owner, as with the position of the handle 2 and of the housing 3 with the outlet opening 6, shown in FIG. 1.

In the area of the circumference of the outlet opening provided in the rotatably mounted housing 3, the leash 4 contacts the housing 3 and the outlet opening 6 and is thus guided. Because of a suitable pretension generated by means of a spring, especially a coil spring or helical spring, the rotatable housing 3 is pretensioned against the handle 2 such that the outlet opening 6 is at the upper end stop in the situation, which is shown in FIG. 1, in which the animal “is heeling” without pulling, so that the distance between the outlet opening 6 and the handle 2 or an angle formed between the pulling direction of the leash and a central axis 10 running in the longitudinal direction of the handle is minimal.

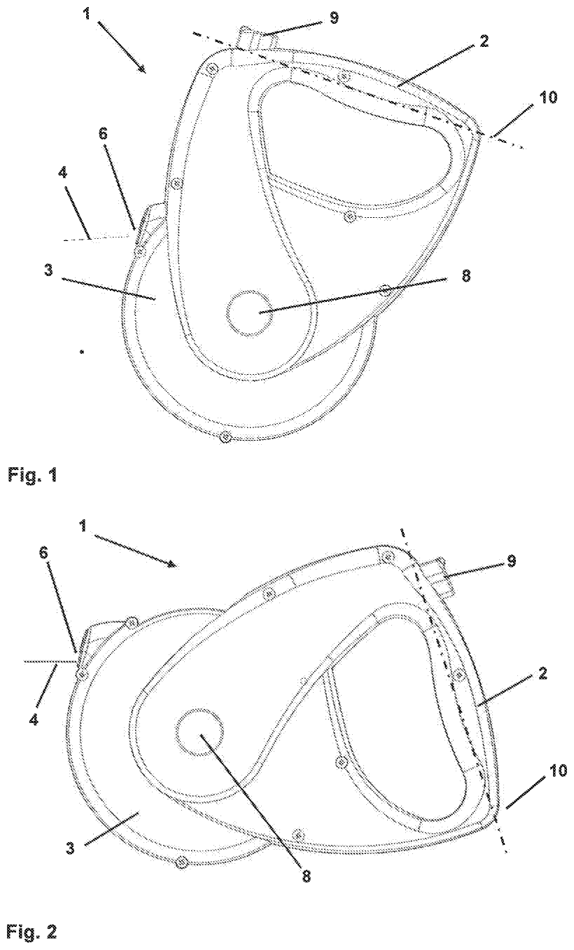

A retractable leash device 1 with a housing part 3, which is configured as rotatable in relation to the handle 2, is shown in FIG. 2, as it is also shown in FIG. 1. FIG. 2 shows the retractable leash device 1, however, in a situation, in which the animal, especially the dog, is pulling on the leash 4 and/or the leash 4, the belt or rope is fully pulled out up to an end stop. The leash 4 is thus located in front of the person leading the dog, so that the pulling is coming from the front and the arm of the animal owner is directed further forwards. In this situation, it is advantageous for the course of the force that the outlet opening 6 is located further away from the handle 2, which is achieved by pivoting the housing 3 with the outlet opening 6 away from the handle 2. In FIG. 2, the outlet opening 6 is located in a position, in which it is at a markedly further distance from the handle 2 than this is the case in the situation shown in FIG. 1. If the outlet opening 6 were located closer to the handle 2 in this situation, this would be disadvantageous in terms of ergonomics, since the hand of the person leading the animal would bend and possibly slide into the corner of the grip opening. Further, this would in turn have the drawback that the friction of the leash would be especially high in the area of the outlet opening 6 due to a kinking of the leash 4. These drawbacks are avoided by the retractable leash device 1 configured with the outlet opening means to move an outlet opening according to the present invention.

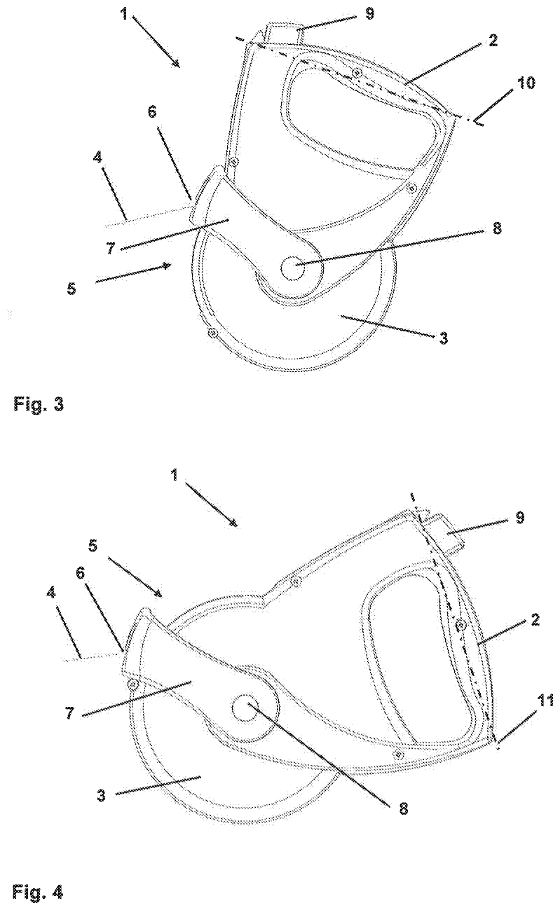

FIG. 3 shows an embodiment of the present invention, in which the retractable leash device 1 configured according to the present invention has a lever element 7, which guides the leash 4 in the form of a carrier and is arranged pivotably about a pivot axis 8 at the housing 3. The outlet opening 6 is located in the lever element 7 and is moved together with same in relation to the handle 2 in case of a pivoting movement of the lever element 7, providing the outlet opening means to move an outlet opening. In this connection, the leash 4 is moved within an outlet area 5 of the housing, which outlet area 5 is at least partly covered by the lever element 7 during the pivot movement.

FIG. 3 shows again a situation, in which the animal being led “heels” and is thus located in the direct vicinity next to the person leading the animal. In this situation, the lever element 7 together with the outlet opening 6 arranged therein is located in a position pivoted towards the handle 2, so that the distance between the outlet opening 6 and the handle 2 and the grip opening is minimal.

The lever element 7 contacts the leash and guides it in the form of a carrier in the area of the outlet opening 6. Because of a suitable pretension generated by means of a spring, especially by means of a coil spring or helical spring, the holding element or lever element 7 is pretensioned such that the outlet opening 6 is located at the upper end stop in the situation shown in FIG. 3, in which the animal “is heeling” without pulling, so that the distance between the outlet opening 6 and the handle 2 or an angle formed between the pulling direction of the leash and a central axis 10 running in the longitudinal direction of the handle is minimal.

The lever element 7 according to FIG. 3 is arranged pivotably about the axis of rotation of the coil, about which the leash 4 is wound up and unwound. The axis of rotation of the coil and the pivot axis 8 of the lever element 7 thus coincide. In this manner, the load of the pivot bearing is minimized in a suitable manner.

Further, the retractable leash device 1 shown in FIG. 3 has a lock or brake for the leash 4, which lock or brake is to be activated by actuation of a pushbutton 9. In this connection, a braking force is introduced comparatively softly rather than with a jerk into the leash 4 in order to optimize the introduction of force into the retractable leash device 1 and thus the operating comfort for the person leading the animal overall.

FIG. 4 shows a retractable leash device 1, which has the technical features already described in connection with FIG. 3. However, FIG. 4 shows the retractable leash device 1 in turn in a situation, in which the animal being led is pulling on the leash 4 and is located at a further distance from the animal owner than in the situation shown in FIG. 3. In this case, the lever element 7 arranged pivotably at the housing 3 with the outlet opening 6 is located in a downwards pivoted position, so that the distance between the outlet opening 6 and the handle 2 is markedly greater in comparison to the situation shown in FIG. 3. Because of the pulling caused by the animal being led, the lever element 7 with the outlet opening 6 was pivoted about the pivot axis 8 into the lower position, so that a linear course of the force is achieved, in which both the hand of the person leading the animal and the leash 4 kink only minimally and ideally run largely tangentially to the coil in the area of the outlet opening 6. The housing 3 with the handle 2 is, furthermore, secure in the hand of the person leading the animal and offers a good counterhold, without the hand being twisted or being pressed against the lower area of the grip opening.

While specific embodiments of the invention have been shown and described in detail to illustrate the application of the principles of the invention, it will be understood that the invention may be embodied otherwise without departing from such principles.

### APPENDIX

### List of Reference Designations

1 Retractable leash device
2 Handle
3 Housing
4 Leash
5 Outlet area
6 Outlet opening
7 Lever element
8 Pivot axis
9 Pushbutton of the lock
10 Central axis in the longitudinal direction of the handle

What is claimed is:

1. A retractable leash device comprising:
a handle;
a housing for the accommodation of a leash for leading animals that can be rolled up and unrolled;
a mechanism provided in the housing, which exerts a restoring force at least at times on the at least partly unrolled leash;
an outlet opening means to move an outlet opening, through which the leash comes out of the housing, into at least two positions in relation to the handle, whereby a pulling direction of the leash and a central axis of the handle, which central axis runs in a longitudinal direction of the handle.

2. A retractable leash device in accordance with claim 1, wherein the outlet opening means comprises an open outlet area of the housing, in which the position of the outlet opening is variable.

3. A retractable leash device in accordance with claim 2, wherein the outlet opening means further comprises at least one cover element with which the open outlet area of the housing is covered in at least some areas.

4. A retractable leash device in accordance with claim 1, wherein the outlet opening means comprises a moveable connection of the housing with the handle whereby the at least partly rolled up leash is arranged movably in relation to the handle.

5. A retractable leash device in accordance with claim 1, wherein the outlet opening means comprises a lever element fastened to the housing, which lever element contacts the leash in at least some areas and through the movement of which the outlet opening is displaced in relation to the housing.

6. A retractable leash device in accordance with claim 5, wherein the lever element is pivotable about an axis, about which the leash is rolled up.

7. A retractable leash device in accordance with claim 1, wherein the mechanism for exerting a restoring force on the leash comprises at least one spring element.

8. A retractable leash device in accordance with claim 1, wherein a lock is provided, by means of which the leash is fixed in an at least partly unrolled position.

9. A retractable leash device in accordance with claim 1, wherein the outlet opening means comprises positioning means to hold the outlet opening, in a nontensioned state of the leash, in a position in which the distance to the handle is minimal.

10. A retractable leash device in accordance with claim 9, wherein the means have at least one spring element.

11. A process for rolling up and unrolling a leash for leading animals, the process comprising the steps of:
providing a retractable leash device comprising a handle, a housing for the accommodation of a leash for leading animals that can be rolled up and unrolled, a mechanism provided in the housing, which exerts a restoring force at least at times on the at least partly unrolled leash, an outlet opening means to move an outlet opening, through which the leash comes out of the housing, into at least two positions in relation to the handle;
at least at times winding up and the accommodated leash; and
at least at times changing an angle between the pulling direction of the leash and a central axis of the handle, which central axis runs in a longitudinal direction of the handle.

12. A process in accordance with claim 11, wherein the outlet opening means comprises an open outlet area of the housing, in which the position of the outlet opening is variable.

13. A process in accordance with claim 12, wherein the outlet opening means further comprises at least one cover element with which the open outlet area of the housing is covered in at least some areas.

14. A process in accordance with claim 11, wherein the outlet opening means comprises a moveable connection of the housing with the handle whereby the at least partly rolled up leash is arranged movably in relation to the handle.

15. A process in accordance with claim 11, wherein the outlet opening means comprises a lever element fastened to the housing, which lever element contacts the leash in at least some areas and through the movement of which the outlet opening is displaced in relation to the housing.

16. A process in accordance with claim 15, wherein the lever element is pivotable about an axis, about which the leash is rolled up.

17. A process in accordance with claim 11, wherein the mechanism for exerting a restoring force on the leash comprises at least one spring element.

18. A process in accordance with claim 11, wherein a lock is provided, by means of which the leash is fixed in an at least partly unrolled position.

19. A process in accordance with claim 11, wherein the outlet opening means comprises positioning means to hold the outlet opening, in a nontensioned state of the leash, in a position in which the distance to the handle is minimal.

20. A process in accordance with claim 19, wherein the means have at least one spring element.
